(19) United States
(12) Patent Application Publication
(10) Pub. No.: US 2009/0210250 A1
(43) Pub. Date: Aug. 20, 2009

(54) Intermediation Server, A Method, And Network For Consulting And Referencing Medical Information

(75) Inventors: Laurent Prax, Mimet (FR); Yannick Kereun, Aix En Provence (FR)

Correspondence Address: YOUNG & THOMPSON, 209 Madison Street, Suite 500, ALEXANDRIA, VA, 22314, US

(73) Assignee: GRED, Paris (FR)

(21) Appl. No.: 11/794,671

(22) PCT Filed: Dec. 26, 2005
(86) PCT No.: PCT/FR2005/003280

§ 371 Date: Jul. 3, 2007

(30) Foreign Application Priority Data
Jan. 4, 2005 (FR) 0500043

(51) Int. Cl. G06Q 50/00; G06F 17/30; H04L 9/32

(52) U.S. Cl. 705/3; 707/10; 726/10; 707/104.1; 707/E17.032; 707/E17.044

(57) ABSTRACT

An intermediation server that can be used to consult and reference medical information relating to patients and stored in a computer network (10) with a plurality of data servers (12, 14, 16), includes an element for creating a shared medical record for a patient that is referenced in the network and an element for indexing medical information relating to the patient in the medical record thereof. Medical information is indexed with the aid of at least one pointer towards the location of the network in which the information is physically stored.

The present invention relates to an intermediation server and to a method for consulting and referencing medical information relating to patients and stored in a computer network comprising a plurality of data servers.

The present invention also relates to a computer network for producing, storing, and consulting medical information relating to patients.

Typically, each medical organization, such as a hospital, a radiological clinic, a biological analysis laboratory, etc. . . . has its own equipment for storing medical information generated during medical acts on patients.

The information relating to a patient is thus generally physically dispersed over a plurality of data servers, and there is no centralized management making it simple for a medical operator, such as a doctor, for example, to access all of the information about said patient.

The object of the present invention is to solve the above-mentioned problem by proposing a centralized system for referencing patient medical information that is stored in decentralized manner.

To this end, the invention provides an intermediation server for consulting and referencing medical information relating to patients and stored in a computer network comprising a plurality of data servers, the intermediation server being characterized in that it comprises:
means for creating a shared medical dossier for a patient referenced in the network, the medical dossier being referenced once only in the intermediation server; and
indexer means for indexing medical information relating to the patient in the patient's medical dossier, with the indexing of medical information comprising at least one pointer to the location in the network where the data is physically stored.

In particular embodiments, the server includes one or more of the following characteristics:
consultation means enabling a user to consult the patient's shared medical dossier via a terminal connected to the server;
selector means for selecting medical information indexed in the patient's shared medical dossier;
sender means for sending to the server storing the selected information a request to download the selected information;
downloader means for downloading the selected medical information from the server;
consultation means for consulting the downloaded medical information through the terminal;
identity manager means adapted to create an identity for the patient on the server and to reference the patient's medical dossier under said identity;
the consultation means access the patient's medical dossier through the patient's identity on the server;
the consultation means comprise user authentication means and authorization means for authorizing an authenticated user to access all or some of a patient's medical dossier as a function of predetermined authorizations associated with the user and stored in the server;
the user is authenticated by means of a secure protocol based on a digital certificate;
the indexing of a patient's medical information in the patient's shared medical dossier includes description data of said information;
an item of medical information comprises at least a header describing the information that is notified to the intermediation server by the server storing the medical information in the event of it being updated, created, or deleted, and the server includes analyzer means for analyzing said header, and indexer means for updating the shared medical dossier of the patient associated with the medical information as a function of the information contained in the header;
when medical information is determined as being emergency information, the data server storing said data notifies the data in full to the intermediation server which references it in the medical dossier of the patient with which it is associated and stores it in emergency data storage means so as to make it directly accessible to an authorized user connected to the intermediation server;
the indexer means are adapted to generate a shared medical dossier that is structured as a function of predetermined types of medical event and episode;
the exchange of information between the intermediation server and a data server or a user terminal is implemented using the SOAP encapsulation protocol; and
medical information includes a digital signature, and the server includes analyzer means for analyzing the signature to authenticate the origin of the data and to determine whether or not it has been corrupted.

The invention also provides an intermediation method for consulting and referencing medical information relating to patients and stored in a computer network comprising a plurality of data servers, the method being characterized in that it comprises the steps consisting in:
creating a medical dossier shared over the network for a patient referenced in the network;
determining, for each item of medical information in the network associated with the patient, a pointer towards the location in the network where the information is stored; and
indexing the medical information in the patient's medical dossier by adding thereto the pointer determined for that medical information.

The invention also provides a computer network for producing, storing, and consulting medical information relating to patients, the network being characterized in that it comprises:
a plurality of data servers each connected to at least one medical information producer device and adapted to store in a database the medical information produced and delivered by the at least one medical information producer device that is connected thereto; and
an intermediation server connected to the plurality of data servers and adapted to receive medical information therefrom, the intermediation server including indexer means for indexing said medical information in respective medical dossiers of patients associated with the information, the indexing of medical information comprising at least a pointer to the location in the network where the information is physically stored.

According to other characteristics, the network includes one or more of the following characteristics:
the intermediation server is of the above-mentioned type;
each medical information producer device is adapted to generate an authentication digital signature for each item of medical information that it produces; and
each data server includes authentication means adapted to authenticate received medical information by analyzing its digital signature.

The invention can be better understood on reading the following description given purely by way of example and made with reference to the accompanying drawings, in which:

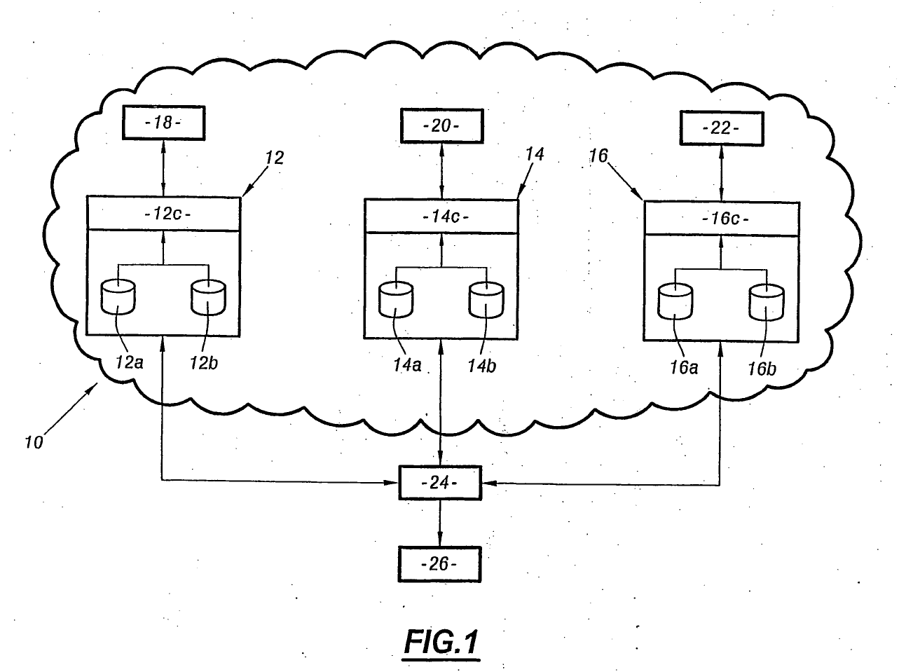

FIG. 1 is a diagrammatic view of a network of data servers storing patient medical information and associated with an intermediation server in accordance with the invention;

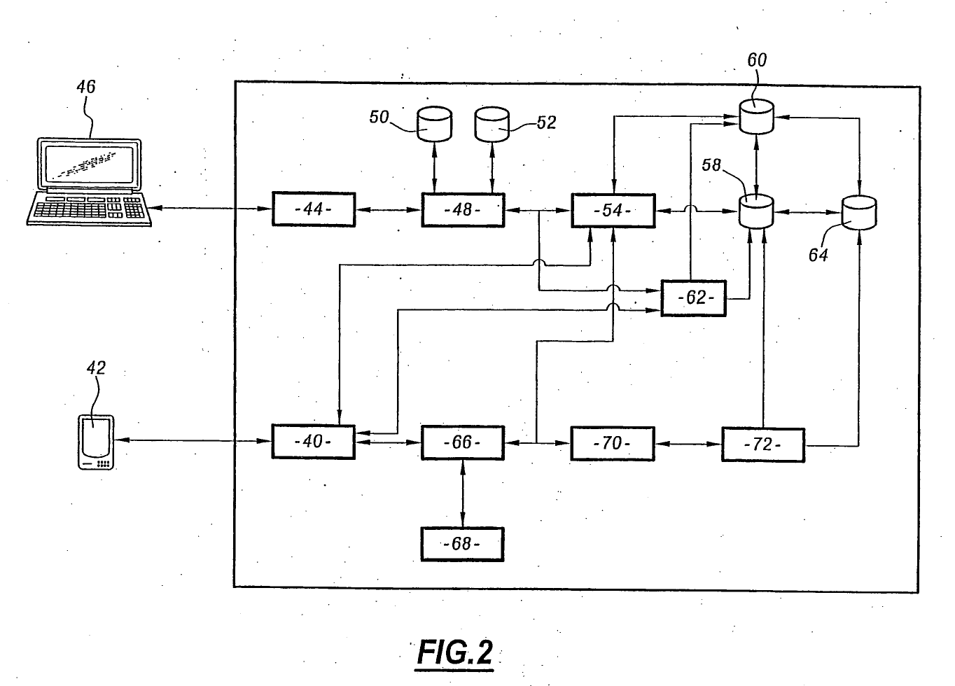

FIG. 2 is a diagrammatic view showing greater detail of the intermediation server forming part of the FIG. 1 network;

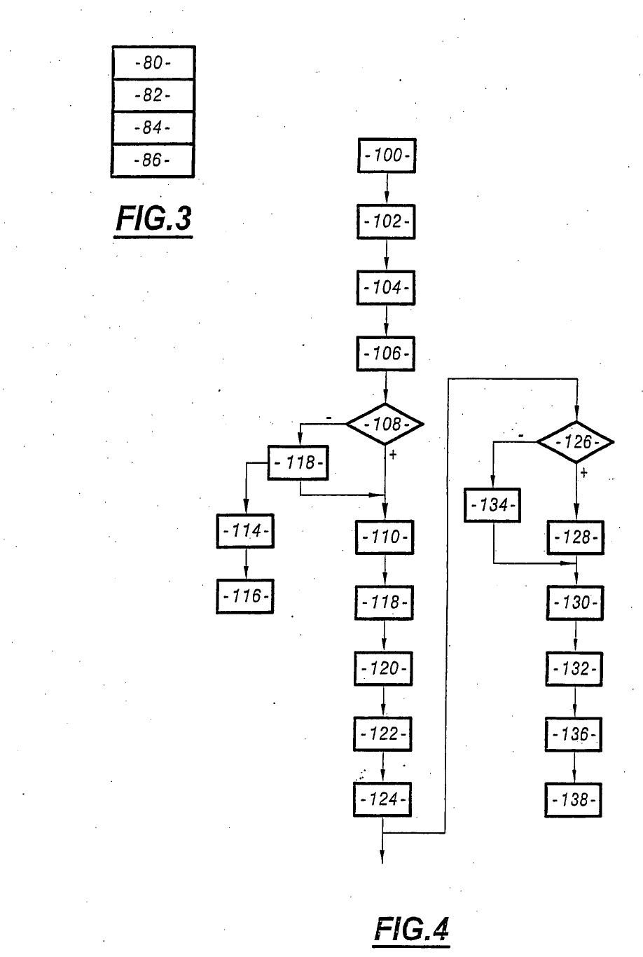

FIG. 3 is a diagrammatic view of a data format used for storing medical information on a data server; and

FIG. 4 is a flow chart of the indexing method used by the intermediation server forming part of the network of FIG. 1.

In FIG. 1, a network 10 for producing and storing medical information relating to patients comprises a plurality of data servers 12, 14, 16, also referred to as content servers.

Each data server 12, 14, 16 forms part of the equipment of a medical organization, such as a hospital for example, and it is connected to devices 18, 20, 22 for producing medical information in a computer format. For example, the data server 12, 14, 16 is connected to a terminal for enabling a medical operator to input the results of biological analyses, reports of operations, etc. . . . , or it is connected to a device for producing radiographs, medical images, etc.

The server 12, 14, 16 comprises a medical information database 12a, 14a, 16a storing the medical information produced by each of the information-producer devices to which it is connected. The server 12, 14, 16 also has a database 12b, 14b, 16b of patient identities storing information relating to patients and referencing their medical information stored in the medical information database 12a, 14a, 16a.

The data server 12, 14, 16 also includes means 12c, 14c, 16c for authenticating the medical information produced and delivered by the producer devices, as explained in greater detail below.

Although the data servers shown are adapted so that each can manage both medical information and the patient identities associated therewith, it will be understood that such services of managing medical information and of managing identities could be implemented on different servers. Similarly, it will be understood that a plurality of medical information management services implemented by distinct data servers could be associated with a single identity management service implemented by a dedicated server or by one of the data servers.

When considering only the servers 12, 14, 16, they do not have a tool enabling the medical information concerning a patient to be consulted in centralized manner. Thus, for example, a doctor seeking to access such information needs to connect with each of the servers 12, 14, 16 in order to consult all of said information.

The production and storage network 10 is advantageously associated with an intermediation server 24 in accordance with the invention. This server is connected to the various data servers 12, 14, 16 and is adapted to index a patient's medical information in a computer medical dossier associated therewith, as explained in greater detail below.

An authorized user, such as a health practitioner or a patient, for example, can connect to the intermediation server 24 by means of a consultation terminal 26, e.g. a personal computer, a personal data assistant, a mobile telephone, etc., that is connected to the server via an information transmission network of the Internet type. The user can then make use of a centralized service for consulting all of the information indexed in the patient's medical dossier, but stored in the data servers 12, 14, 16.

FIG. 2 is a diagrammatic view of the intermediation server of FIG. 1.

The intermediation server comprises a first communication interface 40 for communicating with data servers 42 storing medical information, and a second communication interface 44 for communicating with one or more user terminals 46.

The intermediation server and the external servers 42 make use of an information communication protocol based on notifications and requests/responses, e.g. of the HL7 XML type, and the communications interface 42 is an application service of the Web service type.

In preferred manner, the intermediation server, the data servers, and the user terminals communicate using a SOAP protocol. The information they transmit is encapsulated on each occasion by an encrypted transport envelope and transmitted over a secure transport layer, e.g. of the SSL type.

In addition, a user accesses the intermediation server by means of a light client application, such as a Web browser, for example, and the user interface 48 is an application of the portlet type.

The user interface 44 is connected to an authentication module 48 suitable for identifying the user attempting to connect to the intermediation server. The module 48 notifies the user concerning inputting an identifier and a password, and it compares the identifier and the password input by the user with identifier-and-password pairs stored in a user database 50, or user directory. If the user identifier and password correspond to an identifier-and-password pair in the database 50, the user is then authenticated.

Advantageously, the user also delivers a digital certificate to the intermediation server for strong authentication. By way of example, the certificate can be stored on a smart card delivered to the user by a health organization, and the user terminal includes a smart card reader for reading and delivering the digital certificate to the module 48. The user is then identified if the digital certificate delivered is also validated by the module 48.

If the user is authenticated, the module 48 initializes the connection between the user terminal and the intermediation server. Such connection initialization is performed as a function of predetermined authorizations stored in an authorization database 52 connected to the module 48. The module 48 is adapted to give the authenticated user access rights to the services and the data of the intermediation server as a function of predetermined authorizations for the user in the authorization database 52.

If authorized by the module 48, the authenticated user then has access to a search and consultation service implemented by a search/consultation module 54.

The module 54 is suitable for searching in a database 58 for a patient's computer medical dossier as a function of search information delivered by the user.

The intermediation server has a patient identity database 60 comprising a predetermined set of identities each structured to include such information about the patient.

The identity database 60 is associated with the medical dossier database 58. More particularly, a patient's medical dossier in the database 58 is referenced in the intermediation server by an identity of that patient in the database 60 and is consultable via said identity.

The database 60 is also associated with an identity management module 62 suitable for guaranteeing that each patient is referenced once only in the database 60.

In general, the medical information relating to patients stored in a data server is referenced by patient identities associated with the server. By way of example, the server itself manages said identities, or else the identities associated with the server form part of a set of identities common to a plurality of data servers and managed by a data server or by a dedicated identity server.

By way of example, the data server has its own service for referencing medical information on the basis of said identities. It is therefore possible for a plurality of distinct identities to exist for each patient on the computer network constituted by the data servers.

The module 62 is adapted to process identity information delivered by the data servers and/or by users connected to the intermediation server so as to build and update the. database 60. The module 62 is suitable for managing the database 60 so that it has a single so-called “federating” identity for each patient referenced in the data servers connected to the intermediation server. This unique identity of the intermediation server indexes the various identities of the patient associated with the data servers.

Thus, a user desiring to consult a patient's medical information stored in the data servers gains access thereto via the single federating identity of the patient as stored in the intermediation server.

Advantageously, when a new patient identity is created by the module 62 in the identity database 60, the module 62 also creates a medical dossier, e.g. an initially empty dossier, for that patient in the medical dossier database 58.

The authorized user seeking to consult a patient's medical dossier as stored in the database 58 then interrogates the intermediation server as a function of search information, such as an identity identifier (i.e. an identity reference in the intermediation server), a surname, a forename, or some other information, for example. The search/consultation module 54 then searches the identity database 60 for the identity of the patient that satisfies the information given by the user, and if such an identity exists, it extracts a reference to the dossier associated therewith in the medical dossier database 58.

With the help of this reference, e.g. a pointer to a physical location of the database 58, the search/consultation module 54 then extracts the corresponding medical dossier. The search/consultation module 54 then delivers some or all of the information contained in the medical dossier to the user terminal 46 via the interface 44, the information that is delivered depending on the authorizations for consulting the dossier that are allocated to the user by the module 48.

The database 58 is structured in such a manner as to index in the patient's medical dossier medical information relating to the patient and stored in the data servers connected to the intermediation server. This indexing does not comprise raw medical data, such as a radiograph, for example, but a pointer to the location on the network where the medical information, i.e. the radiograph, is stored, as explained in greater detail below.

This indexing also comprises an information set describing the medical information, whence the use of the term “shared medical dossier” to designate an indexing medical dossier of the database 58.

When the user has selected for consultation some particular medical information indexed in the patient's medical dossier, e.g. by using a selection window displayed on the user's terminal, and once this selection has been notified to the intermediation server, the search/consultation module 54 then issues a request to the data server that physically stores that information. The request comprises information locating the information, e.g. an appropriate reference as determined by the module 54 as a function of the pointer associated with the information in the patient's medical dossier.

In response to the data server receiving this request, the communications interface 40 initializes a downloading link. The requested information is then downloaded and stored in the search/consultation module 54. The user can then consult it via the terminal 46, e.g. by downloading it to the terminal.

In a variant, the interface 40 initializes a direct information download link to the user terminal.

The intermediation server also has an emergency medical database 64 suitable for physically storing emergency information relating to patients, for example a list of medicines to which a patient is allergic. This is particularly advantageous since the data is then directly accessible in centralized manner to help practitioners in the shortest possible time. Because this data is stored directly in the intermediation server, it does not need to be downloaded from a data server in order to be consulted.

The emergency information is also referenced by the identities of the corresponding patients stored in the identity database 60 and indexed in the patient's medical dossier in the medical dossier database 58.

The medical dossier database 58 and the emergency medical database 64 are provided with data as a function of information delivered by the external data servers connected to the intermediation server.

When medical information is stored for the first time, or is updated, or is deleted at a data server, the data server notifies the intermediation server.

The information, or some of it, is then delivered via the communications interface 40 to an information authentication module 66.

The module 66 authenticates the source of the information, in particular its author. As explained in greater detail below, the information delivered by the server includes a digital signature generated with the help of a private key given to its author by a health organization.

The digital signature is decrypted in the module 66 with the help of a public key stored in a key register 68. The decrypted content is then analyzed by the module 66 to determine whether the data has or has not been corrupted, e.g. in transfer between the servers, and to authenticate the author, as is known in the state of the art.

Once the information has been authenticated by the module 66, it is delivered thereby to a content analyzer module 70. The result of this analysis is delivered to an indexing module 72 which indexes the medical information in the patient's medical dossier with which it is associated, as explained in greater detail below.

In preferred manner, the medical information is stored in the data servers 12, 14, 16 in the format shown in FIG. 3.

An item of medical information is generated in the form of a data envelope, e.g. an envelope of the clinical document architecture (CDA) type in the HL7 format.

Such an envelope comprises a metadata header 80, a block 82 of structured data, and/or a block 84 of non-structured data, together with a digital signature 86.

The metadata of the header 80 contains all of the information that is useful for describing and administering the medical information. It defines the nature of the data contained in the blocks 82 and 84 and also the context in which the data was created. By way of example, the metadata comprises information relating to the type of data (operation report, radiograph, prescription, . . . ), a reference to the patient with which the data is associated, a reference of the health practitioner(s) from whom the data originates, references of medical organizations issuing and producing information, information about the current version of the medical information, information describing the medical context in which the information was produced (e.g. while monitoring diabetes, following a surgical operation, . . . ), a creation date, information relating to the administration of the information, such as for example its level of confidentiality and the access authorizations conceded by the patient to various medical actors (doctors, medical organizations, . . . ) that might consult the medical information, or to other parties.

The data blocks 82, 84 comprise one or more medical documents, where such documents may be associated by logical links (as applies to the structured data block 82) for example or may comprise a single block (as applies to the block 84 of non-structured data). By way of example, these blocks may comprise documents in formats such as “Post-Script”, “Portable Document Format”, documents generated by word processors or spreadsheets, etc.

The digital signature 86 is generated by the medical information production device in order to guarantee the integrity, the non-repudiation of the information by the data server to which it is going to be delivered for storage, and the authenticity of the information, i.e. the authenticity of its author in particular. The digital signature 86 is preferably implemented by a signature creation algorithm of the PKI type with the help of a private key given to the health practitioner from whom the information originates.

The flow chart of FIG. 4 shows how medical information is indexed by the intermediation server of FIG. 2.

In a step 100, medical information is modified in the database of a data server. For example, the information is updated by an authorized medical operator connected to the server, deleted by said operator, or is created on the basis of medical data generated by a medical information producer device.

With reference to creation, the medical information producer device generates data associated with a digital signature and with metadata describing the data, and it incorporates all that data in a step 102 in a data envelope of the kind described above with reference to FIG. 3.

The medical information producer device then notifies, in a step 104, the data server to which it is connected of the medical information that has been created, and the data server responds by notifying the device that it has successfully received the information.

In a step 106, the authentication means of the data server authenticates, or do not authenticate, the received information by analyzing its digital signature. If the information is authenticated and not corrupted, the data server notifies the producer device and stores the medical information in the medical information database.

In a following step 108, the data server, or in a variant the server in charge of managing the identities used by the data server, tests whether there exists in its identity database an identity for the patient associated with the medical information. If this identity exists, the server references (step 110) the medical information under this identity, e.g. by creating a specific logical link between its identity and medical information databases.

Otherwise, in a step 112, a new identity is created in the identity database of the data server. By way of example, such creation may be automatic and is performed as a function of information relating to the patient and included in the metadata of the medical information, or it is performed manually by an authorized operator connected to the data server. Step 112 then proceeds with step 110 to reference the medical information.

In addition, the creation of a new identity is notified in step 114 to the intermediation server. In step 116, the identity management module 62 of the intermediation server creates a new identity in the identity database 60 thereof or indexes the new identity created in the data server under an already-existing identity that is associated with the same patient.

Still in 116, if a new identity is created in the intermediation server, the module 62 also creates a medical dossier in the database 58 and indexes the medical dossier under the identity created in the database 58.

In a step 118 following the step 110, the data server delivers all or some of the information that has been modified (i.e. updated, deleted, or created) to the intermediation server.

In a first mode of operation, the data server is suitable for delivering only the metadata of the medical information to the intermediation server.

In a second mode of operation, the data server is suitable for delivering all of the information, in particular when the metadata does not include information needed by the intermediation server for indexing the medical information, or when the medical information is urgent medical information.

The data server encapsulates the medical information, or a portion thereof, in an encrypted transport envelope, locates the intermediation server, and notifies the encapsulated information thereto in a step 120.

In a step 122, the communications interface 40 of the intermediation server receives the information, notifies the data server that it has received the information, and extracts the encapsulated data. After the module 66 has authenticated the information, the analysis module 70, in a step 124, processes the content of the extracted metadata, and in a test 126 verifies whether the metadata has all of the information needed for indexing the information in the medical dossier database 58.

If the metadata contains all of the information needed for indexing purposes, then the analysis module 70 delivers that data in a step 128 to the indexer module 72. In a step 130, the indexer module responds by creating an information set describing the information, determines a pointer to the location of the medical information on the data server, and, in a step 132, updates the patient's medical dossier in the medical dossier database 58. This updating consists in particular in adding a new entry to the dossier containing the pointer and the description information associated with the medical information.

If the metadata does not contain all of the information needed for indexing the medical information, the analysis module 70, in a step 134, analyzes the extracted data in order to generate the missing indexing information, and the step 134 loops to the step 130.

Typically, if the medical information production device and the data server associated therewith do not include a service suitable for generating such information, the data server delivers all of the information to the intermediation server. For example, the analysis module 70 is suitable for recognizing the format of the data contained in each block of medical information data (formats such as “Post-Script”, “Microsoft Word”, etc. . . . ) and for recognizing key words contained therein (such as “operation report”, “prescription”, . . . ) thus enabling it to generate description information.

Furthermore, if the medical information received by the intermediation server is emergency medical information, the indexer means 72 act, in a step 136, to store all of the information physically in the emergency medical information database 64 and, in a step 138, to update the patient's medical dossier, e.g. by specifying the emergency status of the information in the entry corresponding thereto in the medical dossier, and/or adding an “emergency” information entry in the patient's medical dossier.

Preferably, the intermediation server and the data servers that are connected thereto are adapted to store, exchange, index, and present medical information in an event-driven manner.

More particularly, the indexer means 72 are suitable for structuring a patient's medical dossier as a function of medical events and medical episodes. For example, for a patient suffering from diabetes and monitored for that reason by various different actors in the medical field (medical event), the indexer means 72 create a medical event entry (e.g. “monitoring diabetes”) and then creates a sub-entry for that medical event on receiving information relating to an action relating to monitoring the patient's diabetes (medical episode), e.g. a biological analysis of the patient's blood.

1. An intermediation server for consulting and referencing medical information relating to patients and stored in a computer network comprising a plurality of data servers, the intermediation server comprising:
means for creating a shared medical dossier for a patient referenced in the network, the medical dossier being referenced once only in the intermediation server; and
indexer means for indexing medical information relating to the patient in the patient's medical dossier, with the indexing of medical information comprising at least one pointer to the location in the network where the data is physically stored.

2. A server according to claim 1, comprising:
consultation means enabling a user to consult the patient's shared medical dossier via a terminal connected to the server;
selector means for selecting medical information indexed in the patient's shared medical dossier;
sender means for sending to the server storing the selected information a request to download the selected information;
downloader means for downloading the selected medical information from the server; and
consultation means for consulting the downloaded medical information through the terminal.

3. A server according to claim 2, including identity manager means adapted to create an identity for the patient on the server and to reference the patient's medical dossier under said identity.

4. A server according to claim 3, wherein the consultation means access the patient's medical dossier through the patient's identity on the server.

5. A server according to claim 2, wherein the consultation means comprise user authentication means and authorization means for authorizing an authenticated user to access all or some of a patient's medical dossier as a function of predetermined authorizations associated with the user and stored in the server.

6. A server according to claim 5, wherein the user is authenticated by means of a secure protocol based on a digital certificate.

7. A server according to claim 1, wherein the indexing of a patient's medical information in the patient's shared medical dossier includes description data of said information.

8. A server according to claim 1, wherein an item of medical information comprises at least a header describing the information that is notified to the intermediation server by the server storing the medical information in the event of it being updated, created, or deleted, and wherein the server includes analyzer means for analyzing said header, and indexer means for updating the shared medical dossier of the patient associated with the medical information as a function of the information contained in the header.

9. A server according to claim 1, wherein, when medical information is determined as being emergency information, the data server storing said data notifies the data in full to the intermediation server which references it in the medical dossier of the patient with which it is associated and stores it in emergency data storage means so as to make it directly accessible to an authorized user connected to the intermediation server.

10. A server according to claim 1, wherein the indexer means are adapted to generate a shared medical dossier that is structured as a function of predetermined types of medical event and episode.

11. A server according to claim 1, wherein the exchange of information between the intermediation server and a data server or a user terminal is implemented using the SOAP encapsulation protocol.

12. A server according to claim 1, wherein medical information includes a digital signature, and wherein the server includes analyzer means for analyzing the signature to authenticate the origin of the data and to determine whether or not it has been corrupted.

13. A computer network for producing, storing, and consulting medical information relating to patients, the network comprising:
a plurality of data servers each connected to at least one medical information producer device and adapted to store in a database the medical information produced and delivered by the at least one medical information producer device that is connected thereto; and
an intermediation server connected to the plurality of data servers and adapted to receive medical information therefrom, the intermediation server including indexer means for indexing said medical information in respective medical dossiers of patients associated with the information, a patient medical dossier being referenced once only in the intermediation server and the indexing of medical information comprising at least a pointer to the location in the network where the information is physically stored.

14. A network for producing, storing, and consulting medical information relating to patients, the network comprising:
a plurality of data servers each connected to at least one medical information producer device and adapted to store in a database the medical information produced and delivered by the at least one medical information producer device that is connected thereto; and
an intermediation server connected to the plurality of data servers and adapted to receive medical information therefrom, the intermediation server including indexer means for indexing said medical information in respective medical dossiers of patients associated with the information, a patient medical dossier being referenced once only in the intermediation server and the indexing of medical information comprising at least a pointer to the location in the network where the information is physically stored;
wherein the intermediation server is in accordance with claim 1.

15. A network according to claim 13, wherein each medical information producer device is adapted to generate an authentication digital signature for each item of medical information that it produces.

16. A network according to claim 15, wherein each data server includes authentication means adapted to authenticate received medical information by analyzing its digital signature.

17. An intermediation method for consulting and referencing medical information relating to patients and stored in a computer network comprising a plurality of data servers, the method comprising the steps consisting in:
creating a medical dossier shared over the network for a patient referenced in the network and referencing said dossier once only in the intermediation server;
determining, for each item of medical information in the network associated with the patient, a pointer towards the location in the network where the information is stored; and
indexing the medical information in the patient's medical dossier by adding thereto the pointer determined for that medical information.
